(19) United States
(12) Patent Application Publication
(10) Pub. No.: US 2020/0144837 A1
(43) Pub. Date: May 7, 2020

(54) BATTERY CASE FOR WIRELESS CHARGING OF MOBILE DEVICES

(71) Applicant: mophie inc., Irvine, CA (US)

(72) Inventors: Nguyen To, Corona, CA (US); Zhou Hongguo, Shenzhen City (CN); Denny Tsai, Temple City, CA (US)

(21) Appl. No.: 16/672,229

(22) Filed: Nov. 1, 2019

Related U.S. Application Data
(60) Provisional application No. 62/754,469, filed on Nov. 1, 2018.
(60) Provisional application No. 62/789,413, filed on Jan. 7, 2019.

(51) Int. Cl. H02J 7/00; H02J 7/02

(52) U.S. Cl. CPC H02J 7/0045; A45C 2011/002; H02J 7/025

(57) ABSTRACT

A wireless battery case can be used with a mobile electronic device. The wireless battery case can have a back wall, a top wall, a right side wall, a left side wall, and a bottom wall configured such that at least a portion of a bottom of the mobile electronic device is uncovered by the bottom wall. The case can further include a battery coupled to a wireless receiver and a wireless transmitter. The wireless receiver can be configured to receive wireless signals and provide the wireless signals to the battery. The wireless transmitter can be configured to receive the wireless signals from the battery and/or the wireless receiver and wirelessly provide the wireless signals to the mobile electronic device.

### CROSS-REFERENCE TO RELATED APPLICATIONS

This application claims the benefit under 35 U.S.C. § 119(e) of U.S. Provisional Patent Application No. 62/754,469, filed Nov. 1, 2018, and titled BATTERY CASE FOR WIRELESS CHARGING OF MOBILE DEVICES and U.S. Provisional Patent Application No. 62/789,413, filed Jan. 7, 2019, and titled BATTERY CASE FOR WIRELESS CHARGING OF MOBILE DEVICES, each of which is hereby incorporated by reference in its entirety.

### INCORPORATION BY REFERENCE

This application incorporates by reference the entirety of the following: U.S. Pat. No. 9,406,913, issued Aug. 2, 2016, and titled BATTERY CASE FOR MOBILE DEVICES; U.S. Pat. No. 9,077,013, issued Jul. 7, 2015, and titled BATTERY PACK, HOLSTER, AND EXTERNDIBLE PROCESSING AND INTERFACE PLATFORM FOR MOBILE DEVICES. The embodiments disclosed herein can use various features disclosed in the documents that are incorporated by reference.

### BACKGROUND

### Field

Various embodiments disclosed herein relate to wireless battery cases and/or holsters and, in some cases, to an external wireless battery case and/or holster for mobile electronic devices.

### Background

Many mobile devices (e.g., mobile phones, digital assistants, mobile communication devices, handheld computing devices, personal music/video/content players and storage devices) are often powered by battery power sources. Such battery power sources are often housed within the mobile device and may be changed and/or recharged as needed. However, as more powerful mobile devices are designed, these tend to consume power more quickly, thereby shortening the time between charges. This tends to limit the usefulness of the mobile device since the user must find a power source to recharge the battery source and wait until it is recharged.

Therefore, the need exists to extend the time between charges of mobile devices and/or continue to power the mobile device even after an internal power source has been depleted.

### SUMMARY OF CERTAIN EMBODIMENTS

Certain example embodiments are summarized below for illustrative purposes. The embodiments are not limited to the specific implementations recited herein. Embodiments may include several novel features, no single one of which is solely responsible for its desirable attributes or which is essential to the embodiments

Some embodiment can relate to a wireless battery case for use with a mobile electronic device. The wireless battery case can include a back wall configured to extend across at least a portion of a back of a mobile electronic device, a top wall configured to extend along at least a portion of a top of the mobile electronic device, a right side wall configured to extend along at least a portion of a right side of the mobile electronic device, a left side wall configured to extend along at least a portion of a left side of the mobile electronic device, a front opening configured such that a display of the mobile electronic device is visible through the front opening, a battery housed within the back wall of the wireless battery case, a wireless receiver coupled to the battery, and a wireless transmitter coupled to the battery. The wireless receiver can be configured to receive wireless signals. The battery is charged in response to the wireless signals. The wireless transmitter can be configured to receive charging signals from the battery and to wirelessly provide wireless signals to the mobile electronic device in response to the charging signals from the battery.

An external interface can be configured to receive a wired connection for charging the battery. The case can be configured to receive the mobile electronic device so that a mobile device interface of the mobile electronic device is exposed. The mobile device interface can be configured to receive a wired connection. A bottom wall can be configured to extend along at least a portion of a bottom end of the mobile electronic device. The bottom wall can be configured such that at least a portion of a bottom of the mobile electronic device is uncovered by the bottom wall so that the mobile device interface is exposed. The wireless receiver can be coupled to the wireless transmitter, and the wireless receiver can provide charging signals directly to the wireless transmitter without first storing the charging signals in the battery when operating in a bypass mode. One or more of the back wall, the top wall, the right side wall, and the left side wall can be flexible such that the mobile electronic device can pass through the front opening and be securely disposed within the wireless case. The wireless case can be configured to house a smartphone, and the wireless case can have an external shape that generally corresponds to an external shape of the smartphone. The wireless battery case can have an upper case portion and a lower case portion, and the upper case portion can be removable from the lower case portion to facilitate insertion of the mobile electronic device into the case and/or to facilitate removal of the mobile electronic device from the case.

Various embodiments can relate to a wireless battery case for use with a mobile electronic device. The wireless battery case can include a back wall configured to extend across at least a portion of a back of a mobile electronic device, a top wall configured to extend along at least a portion of a top of the mobile electronic device, and a bottom wall configured to extend along at least a portion of a bottom end of the mobile electronic device. The bottom wall can include a recess configured to expose a mobile device interface of the mobile electronic device so that the mobile device interface is able to receive a wired connection while the mobile electronic device is in the case. The case can have a right side wall configured to extend along at least a portion of a right side of the mobile electronic device, a left side wall configured to extend along at least a portion of a left side of the mobile electronic device, a front opening configured such that a display of the mobile electronic device is visible through the front opening, a battery (e.g., housed within the back wall of the wireless battery case), a wireless receiver coupled to receive wireless charging signals, a wireless transmitter configured to transmit wireless charging signals, and an external interface configured to receive a wired connection. A first charging mode can receive wireless charging signals through the wireless receiver and can send corresponding wireless charging signals through the wireless transmitter to the mobile electronic device. A second charging mode can receive wireless charging signals through the wireless receiver for charging the battery of the case. A third charging mode receives electrical power via a wired connection to the external interface, and the electrical power is used to transmit wireless charging signals through the wireless transmitter to the mobile electronic device. A fourth charging mode receives electrical power via a wired connection to the external interface, and the electrical power is used to charge the battery of the case. Any combination of the charging modes can be used.

One or more of the back wall, the top wall, the bottom wall, the right side wall, and the left side wall can be flexible such that the mobile electronic device can pass through the front opening and be securely disposed within the wireless case. The wireless case is configured to house a smartphone, and the wireless case can have an external shape that generally corresponds to an external shape of the smartphone. The wireless battery case can have an upper case portion and a lower case portion, and the upper case portion can be removable from the lower case portion to facilitate insertion of the mobile electronic device into the case and/or to facilitate removal of the mobile electronic device from the case.

Various embodiments can relate to a wireless battery case for use with a mobile electronic device. The wireless battery case can include a back wall configured to extend across at least a portion of a back of a mobile electronic device, a top wall configured to extend along at least a portion of a top of the mobile electronic device, and a bottom wall configured to extend along at least a portion of a bottom end of the mobile electronic device. The bottom wall can be configured such that at least a portion of a bottom of the mobile electronic device is uncovered by the bottom wall. The case can have a right side wall configured to extend along at least a portion of a right side of the mobile electronic device, a left side wall configured to extend along at least a portion of a left side of the mobile electronic device, a front opening configured such that a display of the mobile electronic device is visible through the front opening, a battery (e.g., housed within the back wall of the wireless battery case), a wireless receiver coupled to the battery, and a wireless transmitter coupled to the battery. The wireless receiver can be configured to receive wireless signals, and the battery can be charged in response to the wireless signals. The wireless transmitter can be configured to receive charging signals from the battery and to wirelessly provide wireless signals to the mobile electronic device in response to the charging signals from the battery.

The wireless battery case can have an external interface configured to receive a wired connection for charging the battery. The external interface can be configured to provide electrical power to the wireless transmitter. The external interface can be a USB port. The wireless receiver can be configured to provide electrical power to another mobile electronic device. The wireless receiver can be configured to switch between a receiving mode and a transmitting mode. The wireless receiver can be coupled to the wireless transmitter, and the wireless receiver can provide charging signals directly to the wireless transmitter without first storing the charging signals in the battery when operating in a bypass mode. The charging signals can comprise electrical power. The wireless receiver can have a wireless charging receiver coil. The bottom wall can provide access for a wired connector to engage a corresponding interface of the mobile electronic device. One or more of the back wall, the top wall, the bottom wall, the right side wall, and the left side wall can be flexible such that the mobile electronic device can pass through the front opening and be securely disposed within the wireless case. The wireless case can be is configured to house a smartphone, and the wireless case can have an external shape that generally corresponds to an external shape of the smartphone. The wireless battery case can have a charge indicator configured to indicate the charge status of the battery. The charge indicator can have a plurality of light emitting diodes (LEDs). The wireless battery case can have an upper case portion and a lower case portion, and the upper case portion can be removable from the lower case portion to facilitate insertion of the mobile electronic device into the case and/or to facilitate removal of the mobile electronic device from the case. The wireless battery case can include vents for cooling an interior of the case.

### BRIEF DESCRIPTION OF THE DRAWINGS

Certain embodiments will be discussed in detail with reference to the following figures, wherein like reference numerals generally refer to similar features throughout. These figures are provided for illustrative purposes and the embodiments are not limited to the specific implementations illustrated in the figures.

FIG. 1 illustrates a block diagram for a wireless battery case for a mobile device according to one example.

FIG. 2 illustrates a block diagram for the wireless battery case of FIG. 1 and a wireless charger according to one example.

FIG. 3 illustrates a front perspective view of an example embodiment of a wireless battery case.

FIG. 3A illustrates a front perspective view of the wireless battery case of FIG. 3 with a mobile electronic device therein.

FIG. 3B illustrates a back view of the wireless battery case of FIG. 3.

FIG. 4 schematically illustrates a front view of an example embodiment of a wireless battery case.

FIG. 5 schematically illustrates a back view of an example embodiment of a wireless battery case.

FIG. 6 illustrates a bottom view of the wireless battery case of FIG. 3 and a mobile device housed within the wireless battery case.

FIG. 6A shows a two-piece case in an open configuration, with an upper case portion separated from a lower case portion.

FIG. 6B shows a two-piece case in an open configuration, with an upper case portion separated from a lower case portion.

FIG. 6C shows a two-piece case in a closed configuration, with the upper case portion attached to the lower case portion.

FIG. 7 illustrates a block diagram for a wireless battery attachment and case according to one example.

FIG. 8 illustrates a perspective view of an example embodiment of a wireless battery attachment and case.

FIG. 9 is a front perspective view of an example embodiment of a battery attachment.

FIG. 10 is a rear perspective view of an example embodiment of a battery attachment.

FIG. 11 shows an example embodiment of a battery attachment coupled to a case.

### DETAILED DESCRIPTION OF CERTAIN EMBODIMENTS

In the following detailed description, numerous specific details are set forth in order to provide a thorough understanding of the embodiments. However, the embodiments may be practiced without these specific details. In other instances, well known methods, procedures, and/or components have not been described in detail so as not to unnecessarily obscure inventive aspects of the disclosure.

Various embodiments provide wireless battery cases shaped to conform to the external shape of a mobile device, thereby providing a permanent or long-term replacement power source without significantly affecting the size and usability of the mobile device.

According to one feature, the wireless battery case may provide recharge power to the mobile device while also providing an external signaling and/or charging interface to the mobile device. This way, the mobile device need not be removed from the wireless battery case in order to charge it or to communicate with an external device (e.g., to provide or receive data, such as for synchronization, etc.).

According to yet another feature, the wireless battery case may include one or more different types of communication interfaces to extend the communication capabilities of the mobile device. This allows the mobile device to communicate via other interfaces that may not be built into the mobile device.

According to yet another feature, the wireless battery case may include one or more processors to extend the processing capabilities of the wireless battery case. For instance, the one or more processors may increase the processing capabilities of the wireless battery case and/or provide purpose-specific processors. That is, the interface between the wireless battery case and mobile device may allow the mobile device to use the one or more processors to execute application on the wireless battery case. Now that such applications may, in some instances, continue to operate even if the mobile device is detached from the wireless battery case.

According to yet another feature, the wireless battery case may utilize wireless charging, and can include an inductive recharging device or a near-distance recharging device so that its power cells may be recharged without actually physically plugging it to a recharge power source.

Wireless Battery Case

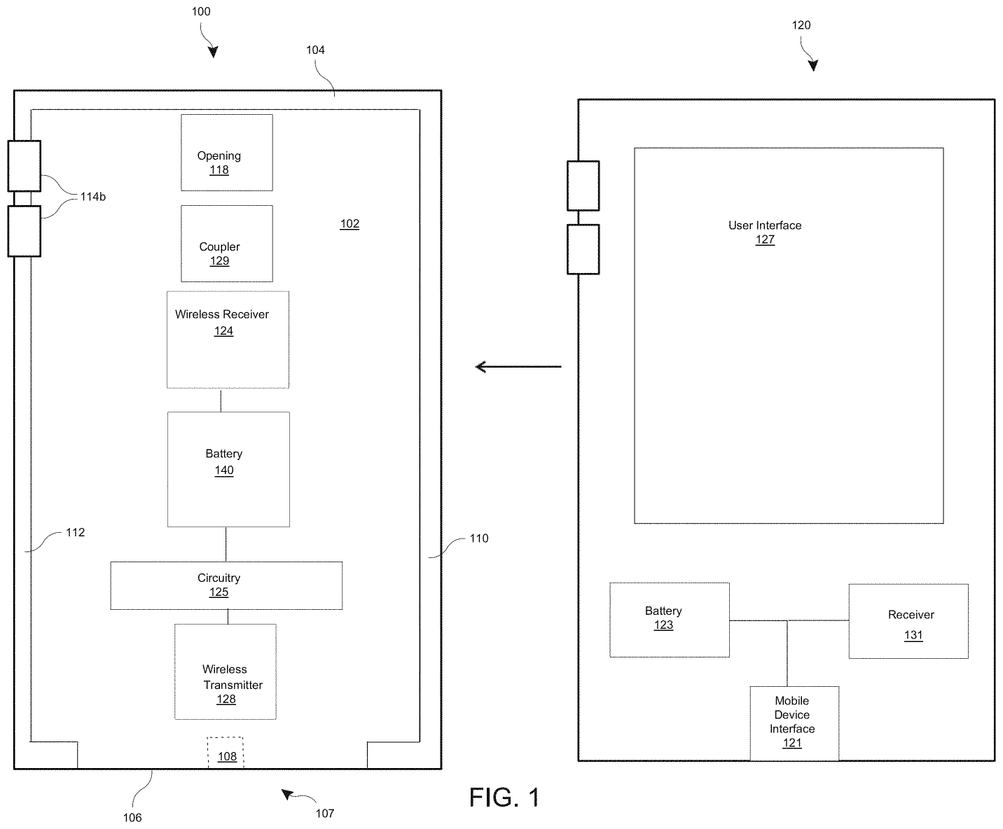

As shown in FIG. 1, the wireless battery case 100 can include a back wall 102 that is configured to extend across at least a portion of a back of the mobile electronic device 120. The case 100 can include a top wall 104 configured to extend along at least a portion of a top of the mobile electronic device 120. The case 100 can include a bottom wall 106 configured to be located proximate a bottom of the mobile electronic device 120. In some embodiments, the bottom wall 106 can comprise an alcove or recess 107 configured to provide access to a bottom of the mobile device 120 (e.g., to access a device interface and/or speakers on the mobile device 120). The case 100 can include a right side wall 110 configured to extend along at least a portion of a right side of the mobile electronic device 120. The case 100 can include a left side wall 112 configured to extend along at least a portion of a left side of the mobile electronic device 120. The case 100 can include a front opening configured such that a display (e.g., a touchscreen configured to receive a user input such as a touch input via a finger(s) or hand(s)) of the mobile electronic device 120 is visible through the front opening when the mobile electronic device 120 is in the case 100. One or more of the back wall 102, the top wall 104, the bottom wall 106, the right side wall 110, and the left side wall 112 can be flexible such that the mobile electronic device 120 can pass through the front opening and be securely disposed within the wireless case 100. The wireless case 100 can include one or more features (e.g., openings, button covers, and/or switch covers) that are configured to provide access to one or more corresponding features (e.g., buttons, ports, and/or switches) on the mobile electronic device 120. An opening (not shown) through a wall of the case 100 can be disposed to align with a button or switch (e.g., a mute switch) on the mobile electronic device 120 to enable a user to operate the button or switch through the opening. Button covers 114b can be disposed to align with buttons (e.g., volume buttons and/or an on/off button) on the mobile electronic device 120 to enable a user to operate the buttons on the mobile device 120 via the button covers 114b. In some embodiments, the case 100 can include a switch cover (not shown) that is configured to interface with a switch on the mobile electronic device 120 to operate the switch. A camera opening 118 can be positioned (e.g., through the back wall 102) to align with a camera and/or camera flash on the mobile electronic device 120 so that the camera of the mobile electronic device 120 can operate while the mobile electronic device 120 is in the case 100.

The case 100 can have an external shape that generally corresponds to the external shape of the mobile device 120. Accordingly, a case 100 designed for use with a smartphone can have an external shape that generally corresponds to the external shape of the smartphone. Accordingly, the case 100 with the smartphone therein can be used in the same manner as the smartphone without the case 100. For example, the case 100 with the smartphone therein can be placed in a user's pocket, can be held in a single hand with the thumb operating the touchscreen, can comfortably be held to the user's face when talking on the phone, etc. The case 100 can provide protection to the mobile device 120 that is disposed therein.

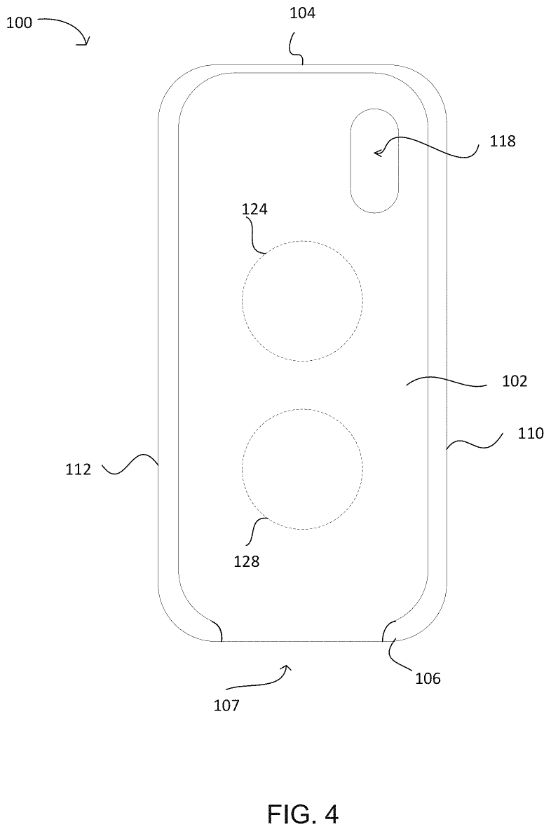

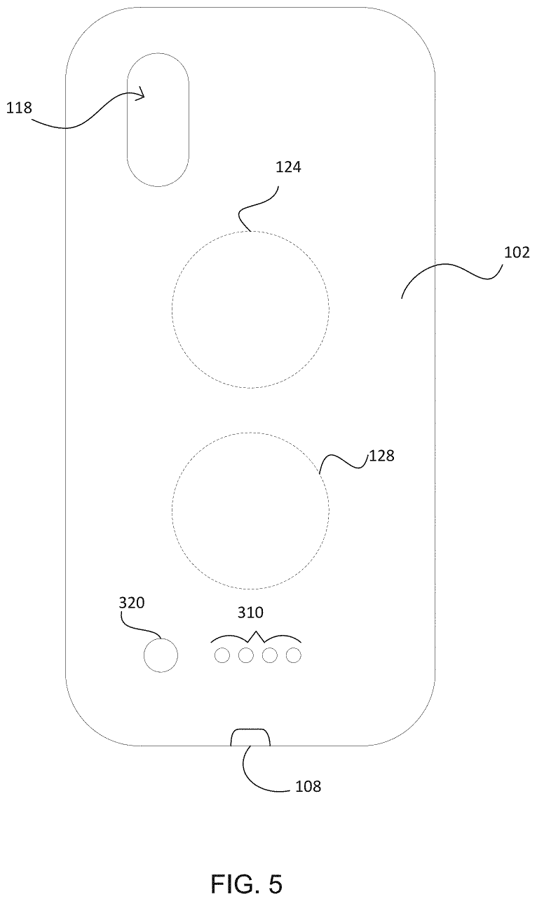

The wireless battery case 100 has a battery 140 (e.g., an integrated rechargeable power cell) capable of providing power to operate and/or recharge a mobile device (e.g., a smartphone, tablet, handheld computer, etc.). The wireless battery case 100 can further include a wireless receiver 124 and a wireless transmitter 128. In FIGS. 4 and 5, the wireless receiver 124 and the wireless transmitter 128 are shown by dashed lines, which can indicate the location of internal coil antennas. The location of the wireless receiver 124 and the wireless transmitter 128 can vary. The wireless receiver 124 and wireless transmitter 128 can be disposed in the thickness of the back wall 102 such that the wireless receiver 124 and wireless transmitter 128 can be configured to be behind (rearward) of the back of the mobile electronic device 120. Some or all of the additional circuitry 125 and/or other components (e.g., wire(s) connecting the wireless receiver to the battery 127 and/or the wireless transmitter 128) can also be disposed in the thickness of the back wall 102. By way of example, the circuitry 125 can include an alternating current (AC) to direct current (DC) converter, a voltage regulator, a current limiter, and/or other electrical components to facilitate charging of the battery 140 using the signals received by the wireless receiver 124, to facilitate transfer of electrical power to the mobile device 120 (e.g., via the wireless transmitter 128), and/or to facilitate other functionality disclosed herein. In FIGS. 4 and 5, the wireless receiver 124 and the wireless transmitter 128 have a non-overlapping configuration. In some embodiments, the wireless receiver 124 and the wireless transmitter 128 can partially or completely overlap. For example, a line extending from the front of the case 100 to the back of the case 100 can pass through both the wireless receiver 124 and the wireless transmitter 128. At least a portion of the wireless receiver 124 can be positioned directly rearward of the wireless transmitter 128. In some cases, the wireless receiver 124 can be positioned on a back side of the battery 140 and the wireless transmitter 128 can be positioned on a front side of the battery 140. The battery 140 can be positioned between the wireless receiver 124 and the wireless transmitter 128.

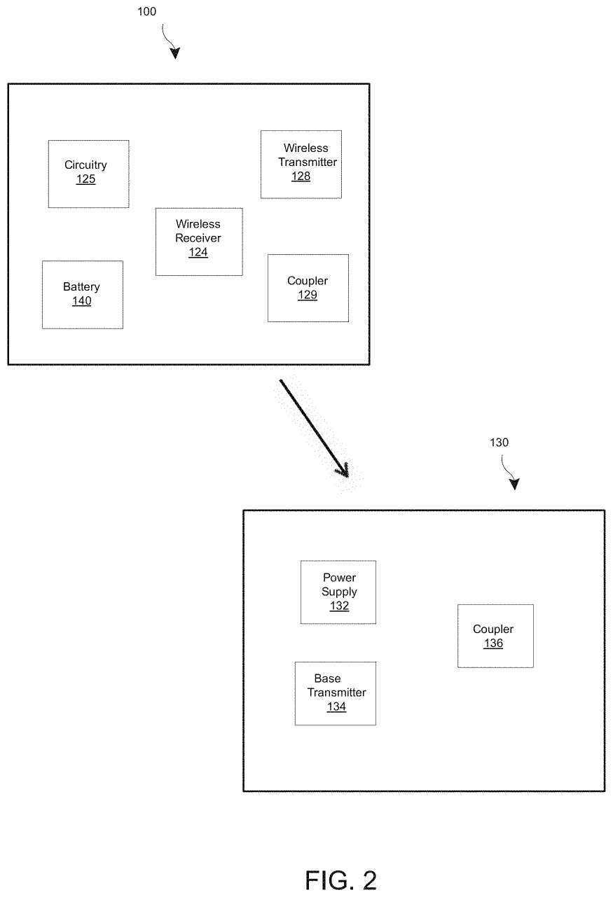

As illustrated in FIG. 2, the case 100 can optionally include a coupler 129, such as one or more magnets to facilitate alignment and/or attachment with a wireless charger 130 (such as a docking station, a charging pad, or a wireless external battery pack). The wireless charger 130 can support or provide wireless charging capabilities via a base transmitter 134 (e.g., a wireless transmitter coil or other suitable antenna) configured to transmit wireless signals to the case 100. Such alignment may facilitate proper coupling of the case 100 to the wireless charger 130 so that the wireless receiver 124 of the case 100 is properly positioned relative to the base transmitter 134 of the charger to enable, improve, or optimize wireless charging. The wireless charger 130 can include a coupler 136 configured to couple the case 100 with the charger 130 in a predefined position and/or orientation. In some embodiments, the coupler 136 comprises one or more magnets configured to attract with one or more magnets on the case 100. For example, the charger may also include one or more magnets, such that when the case 100 is placed within magnetic range of the charger, the one or more magnets in the case 100 are pulled towards and aligned with the one or more magnets in the charger 130. Respective wireless charging input and/or output interfaces in the case 100 and the charger 130 may be positioned such that when the one or more magnets of the case 100 align with the one or more magnets of the charger 130, the wireless input/output interfaces may also be aligned or otherwise in sufficiently close proximity to enable wireless transfer of electrical power (e.g., by induction). The charger 130 may comprise a power supply 132, which can provide electrical power to the base transmitter 134 of the charger 130. The power supply 132 can be configured to receive electrical power from an external source (e.g., an electrical outlet). In some cases, a wire can couple the charger 130 to an electrical outlet or other external source. The power supply 132 can be a battery, for example when the wireless charger 130 is a wireless charging battery pack.

As further illustrated in FIG. 2, the case 100 can be placed adjacent to (e.g., on top of) the charger 130 in order to begin receiving wireless signals. By way of example, if a user places the case 100 onto the charger 130, but at a location where the base transmitter 134 and the wireless receiver 124 are positioned further apart than desired, the forces (e.g., attraction) between the magnet(s) of the case 100 and the magnet(s) of the charger 130 can cause the case 100 to move so as to bring the wireless receiver 124 closer to the base transmitter 134. In some embodiments, the orientation of the wireless receiver 124 relative to the base transmitter 134 can affect the wireless charging, and the couplers 129 and 136 can be configured to position the case 100 relative to the charger 130 such that the wireless receiver 124 is oriented relative to the base transmitter 134 at a charging orientation that is configured to enable, improve, or optimize wireless charging. By way of example, if a user places the case 100 onto the wireless charger 130 at an orientation that is offset rotationally by 20 degrees from the charging orientation, the forces (e.g., attraction and/or repulsion) between the magnet(s) of the case 100 and the magnet(s) of the charger 130 can rotate the case by 20 degrees to the charging orientation. In some embodiments, the case 100 can have a single charging orientation. In some embodiments, the case 100 can have multiple suitable charging locations (e.g., four charging locations offset from each other by 90 degrees). Many alternatives are possible. In some embodiments, the couplers 129, 136 may be one or more latches or clips or suction elements or other engagement mechanisms configured to secure the case 100 to the charger 130 (e.g., in a proper orientation). In some embodiments, the shape or design of the charger 130 and/or the case 100 may encourage a user to place the case 100 on the charger 130 in the proper orientation. For example, the charger 130 can have a shape, size, and/or aspect ratio, etc. that is similar to the case 100, so that placement of the case 100 onto the charger 130 with the shapes, sizes, and/or aspect ratios, etc. co-aligned causes the base transmitter 134 and the wireless receiver 124 to be positioned and/or oriented to enable, improve, or optimize wireless charging. The charger 130 and/or case 100 can use a metal or other magnetic material instead of the one or more magnets, in some cases.

The wireless receiver 124 can be configured to receive wireless signals, such as inductive charging signals for charging the battery 140 and/or mobile electronic device 120 or data transfer (e.g., via electrical circuitry 125). For example, wireless charging signals can be received by the wireless receiver 124 via magnetic/electromagnetic fields provided by the wireless charger 130 (e.g., through magnetic resonance, inductive power transfer, or any other suitable kind of wireless signal transfer).

In some embodiments, the wireless receiver 124 is a wireless antenna, such as a coil antenna. As a non-limiting example, the base transmitter 134 can comprise a transmitter circuit and a transmitter antenna (e.g., a coil). The transmitter circuit can send alternating current to the transmitter coil. The alternating current flowing within the transmitter coil can create a magnetic field, which can extend to a receiver coil (e.g., of wireless receiver 124 when the case 100 is within a threshold distance from the wireless charger 130). The magnetic field can generate alternating current within a coil of the wireless receiver 124, which in some implementations can be converted into direct current (e.g., by an AC-DC converter in the other circuitry 125) for storage in the battery 140. The power stored in the battery 140 may be converted into alternating current and transmitted to the wireless transmitter 128 where it can be used to create a magnetic field, which can extend to the mobile receiver 131. In some embodiments, the current generated in the wireless receiver 124 may remain alternating current and travel directly to the wireless transmitter 128, bypassing the battery 140. In some embodiments, a single coil is used for both the wireless receiver 124 and the wireless transmitter 128. The single coil can be configured to toggle between a receiving mode (e.g., to charge the battery 140) and a transmitting mode (e.g., to charge the mobile device 120).

In some embodiments, the wireless receiver 124 can be configured to operate in a receiving mode or a transmitting mode. When in the receiving mode, the wireless receiver 124 can operate in a similar fashion as described above. However, when operating in the transmitting mode, the wireless receiver 124 can be configured to generate a magnetic field using current drawn from the battery 140 and/or the external interface 108 (e.g., which can be a port for receiving electricity via a wire). The generated magnetic field can then be used to induce a current in a corresponding device that is proximate the rearward side of the back wall 102 of the wireless battery case 100. In this manner, the wireless battery case 100 can provide wireless signals to two mobile devices. For example, signals can be sent from the battery 140 both to the wireless transmitter 128 (e.g., in order to charge the mobile device 120) and to the wireless receiver 124 in the transmitting mode (e.g., in order to charge a corresponding device that is proximate the rearward side of the back wall 102). In some embodiments, the case 100 can be configured to prevent simultaneous transmission of wireless signals by both the wireless transmitter 128 and the wireless receiver 124 in transmitting mode, such as to avoid overheating. In some embodiments, the wireless transmitter 128 and the wireless receiver 124 in transmitting mode can operate simultaneously, such as for charging two devices at the same time. In some embodiments, a temperature sensor can be used, and the case 100 can be configured to enable and/or disable simultaneous dual charging based at least in part on the measured temperature (e.g., of the case 100). For example, when the measured temperature is over a threshold, the case 100 can disable simultaneous dual charging, and when the measured temperature is below a threshold, the case can enable simultaneous dual charging.

In some embodiments, the wireless receiver/transmitter 124 and/or the wireless receiver/transmitter 128 can be configured to transfer data to and/or from an external computing device and the mobile electronic device 120 while the mobile electronic device 120 is in the case 100. Accordingly, the mobile electronic device 120 can use the wireless receiver/transmitter 124 and/or the wireless transmitter/receiver 128 of the case 100 to wirelessly sync with, or otherwise communicate with, an external computing device while in the case 100. Thus, in some embodiments, the wireless receiver/transmitter 124 of the case 100 can be used for receiving and/or transmitting wireless data signals (e.g., for data communication with an external computing device) in addition to, or instead of, receiving wireless charging signals. For example, the external computing device can have features similar to those discussed in connection with the wireless charger 130, wherein a transmitter/receiver (e.g., an antenna) is configured to wirelessly send and/or receive data to and/or from the wireless receiver/transmitter 124 of the case 100. The external computing device can have a hardware processor and computer readable memory for sending and/or receiving data to and/or from the transmitter/receiver 134 for communicating with the mobile device 120 through the case 100. In some embodiments, the base or charger 130 can connect with the external computing device (e.g., via a wired or wireless data connection). The base or charger 130 can then wirelessly provide the data communication with the wireless receiver/transmitter 124, such as by using the base transmitter/receiver 134. Data can be transferred between the wireless receiver/transmitter 124 and the wireless transmitter/receiver 128 via electrical circuitry 125 such that the data can be transferred to and/or from the mobile electronic device 120 via the wireless transmitter/receiver 128. Data from the mobile electronic device 120 can be transferred wirelessly to the transmitter/receiver 128, then the data can be transferred to the receiver/transmitter 124 (e.g., via circuitry 125), then the data can be transmitted wirelessly by the wireless receiver/transmitter 124 to an external computing device, such as the wireless charger 130, a computer (not shown), etc. The data communication can be to two-way data communication, or the case 100 can be configured to provide only one-way data communication, either from the mobile electronic device, through the case, to an external device, or from an external device, through the case, to the mobile electronic device that is in the case. In some embodiments, the data can be communicated (wirelessly or by a wired connection) from and/or to the mobile electronic device directly to and/or from the external computing device. The wireless transmitters and receivers discussed herein can be used for both receiving and transmitting data and/or charging signals.

In some embodiments, the case 100 can include an external interface 108, which can be a port configured to receive a wired connection, such as for receiving electricity for charging the battery 140 and/or powering the mobile electronic device 120. In some cases, the external interface 108 can be used for data communication to and/or from the mobile electronic device 120. For example, the mobile electronic device 120 can wirelessly send and/or receive data via the wireless transmitter/receiver 128, and that data can be transferred between the wireless transmitter/receiver 128 and the external interface 108 (e.g., via the circuitry 125), so that an external computing device can send and/or receive the data via a wired connection to the external interface 108. Accordingly, data can be transferred through the case using both wireless and wired communication types, in some embodiments.

As shown in FIG. 5, the case 100 can include a charge indicator 310, which can be configured to indicate a charge level of the battery 140 in the case 100. The charge indicator 310 can include a plurality of lights, such as light emitting diodes (LEDs), and the number of lights that are illuminated can indicate the amount of charge that the battery 140 of the case 100 has remaining. For example, four lights can be used, and one illuminated light can correspond to about 25% charge, two illuminated lights can correspond to about 50% charge, three illuminated lights can correspond to about 75% charge, and four illuminated lights can correspond to about 100% charge. In some embodiments, the charge indicator 310 can use different colors, the intensity of light, or a display with a text or image representation to indicate the charge level of the battery 140. In some embodiments, the case 100 can include a switch or button or other user input element 320 configured to initiate or terminate wireless charging to the mobile device 120 using the batter 140, or to provide other input to the case 100. In some embodiments, one or more of the lights of the charge indicator 310 can illuminate in response to input received by the user input element 320. In some embodiments, the user input element 320 can be used to switch a coil between a transmitting mode and a receiving mode. Although a single user input element 320 is shown in FIG. 5, some embodiments can include multiple user input elements for different input functions, such as turning the charging on, turning the charging off, outputting battery charge information (e.g., via the charge indicator 310), and the various other functions discussed herein.

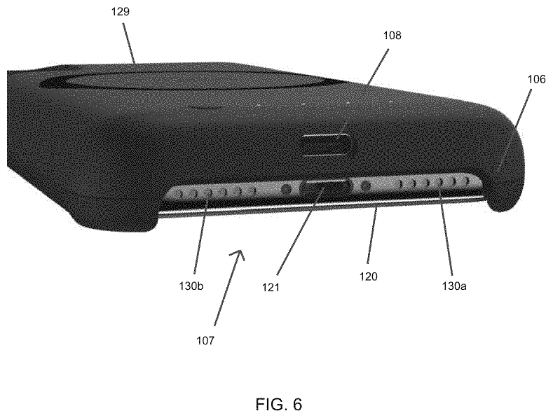

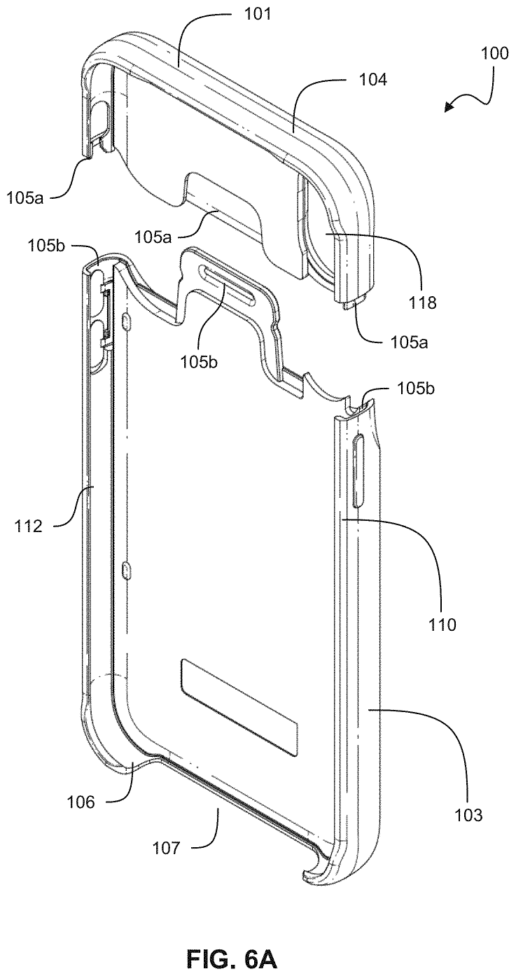

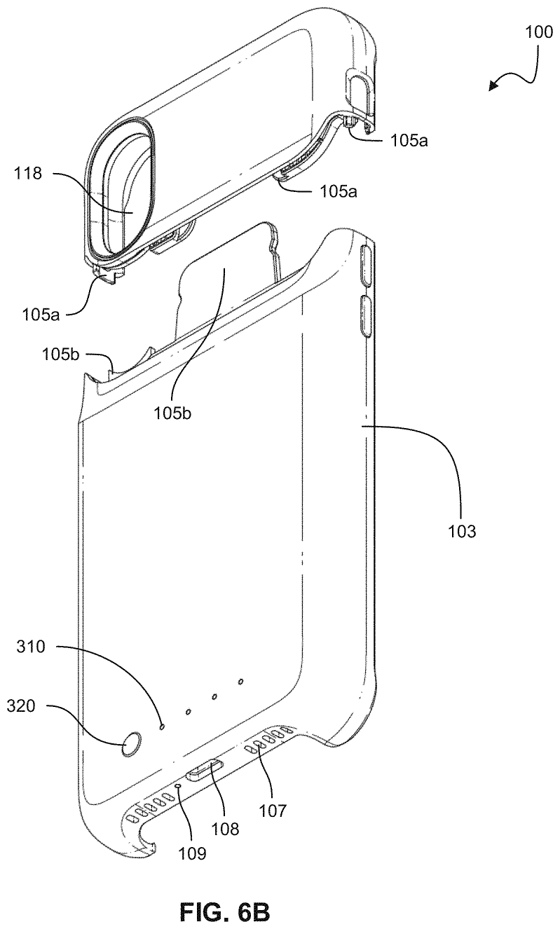

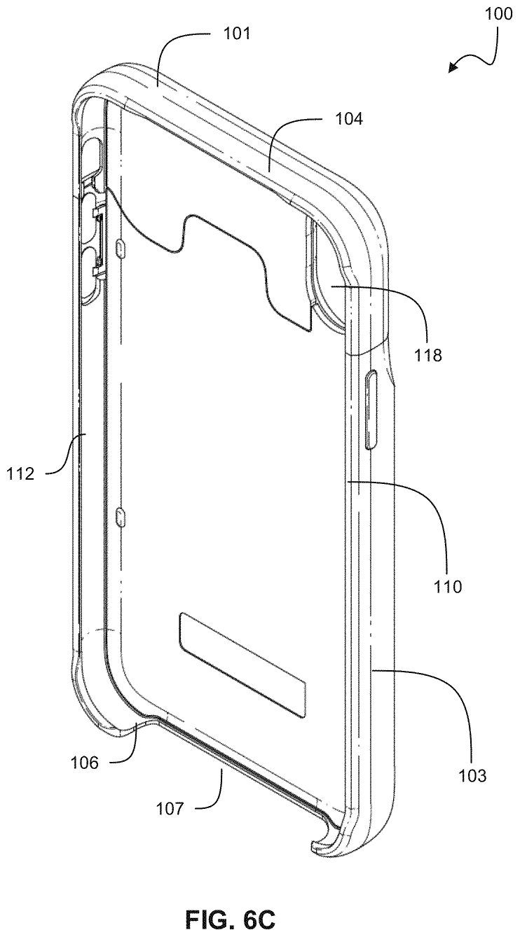

FIG. 6 illustrates a bottom view of the wireless battery case 100 housing a mobile device 120. In this view, the bottom wall 106 of the wireless battery case 100 is shown. The bottom wall 106 can include an external interface 108 (e.g., USB type-C input connector port, micro USB connector port, etc.). This external interface 108 may serve to recharge the battery 140. Additionally, the external interface 108 may also provide a pass-through signaling interface, thereby allowing the mobile device 120 to communicate via the external interface 108. FIG. 6 further illustrates the recess 107 in the bottom wall 106 of the wireless battery case 100. As shown, the recess 107 can be shaped such that the bottom wall 106 does not cover or block at least a portion of the bottom of the mobile device 120. For example, the recess 107 can be shaped such that a device interface 121 and one or more speakers and/or microphones 130a, 130b on the bottom of the mobile device 120 are left uncovered. Despite the recess 107, the bottom wall 106 can be designed such that the bottom of the mobile device 120 remains substantially protected from impacts. For instance, the bottom wall 106 can include bumpers configured to cover bottom corners of the mobile device 120. In some cases, when the mobile electronic device 120 is in the case 100, the mobile device interface 121 of the mobile electronic device 120 and the external interface 108 of the case 100 can align (or at least partially overlap), such as in the direction extending between the front and back of the case 100. The mobile device interface 121 and the external interface 108 can be spaced apart so that a first connector can be connected to the mobile device interface 121 at the same time that a second connector is connected to the external interface 108. In some embodiments, the external interface 108 can be offset (e.g., to the right or left) from the position of the mobile device interface 121, to facilitate connection of both the first and second connectors to the corresponding interfaces 121 and 108 at the same time. The mobile device interface 121 can be a port configured to receive a wired connector (e.g., a USB port or Lightning port). In some cases, the case 100 can be configured so that a majority of the bottom of the mobile device is exposed, or so that the entirety of the bottom of the mobile device is exposed. The external interface 108 of the case 100 can be spaced apart from the mobile device interface 121 by a distance that is no more than about 50 mm, no more than about 40 mm, no more than about 30 mm, no more than about 25 mm, no more than about 20 mm, no more than about 15 mm, no more than about 10 mm, no more than about 5 mm, no more than about 3 mm, no more than about 2 mm, or any values or ranges therebetween, although other configurations are also possible.

With reference to FIGS. 6A to 6C, in some embodiments, the case 100 can be a two-piece case, having an upper portion 101 and a lower portion 103. FIGS. 6A and 6B show the case in an open configuration, with the upper portion 101 separated from the lower portion 103. FIG. 6C shows the case in a closed configuration, with the upper portion 101 attached to the lower portion 103. The case 100 can include engagement structures 105a on the upper portion 101 that can releasable engage with engagement structures 105b on the lower portion 103 to couple the upper portion 101 to the lower portion 103. The engagement structures 105a and 105b can be clips, snaps, friction-fit features, clasps, pins, protrusions, holes, or the like. The upper portion 101 can include the upper wall 104 and the camera opening 118. In some cases, the upper portion 101 can include upper portions of the right side wall 110 and the left side wall 112. The lower portion 103 of the case 100 can include the lower wall 106 and the recess 107. The lower portion 103 can include lower portions of the right side wall 110 and the left side wall 112. The lower portion 103 can include the supplemental battery 140, circuitry 125, wireless receiver 124, wireless transmitter 128, external interface 108, charge indicator 310, and user input element 320, similar to other embodiments discussed herein.

The upper case portion 101 can be removed from the lower case portion 103 to facilitate inserting of the mobile device into the case 100 and/or removal of the mobile device from the case 100. The side walls of the case 100 can be sufficiently rigid so that the mobile device would not be easy to insert through the front opening of the case. The upper portion 101 can be removed, and the mobile device can be slide into the lower portion 103. The mobile device can be inserted between the right side wall 110 and the left side wall 112, and slide downwards toward the lower wall 107. Once the mobile device is seated in the case 100, the upper case portion 101 can be attached to the lower case portion 103 to encase the mobile device in the case 100. For removal, the upper case portion 101 can be detached, and the mobile device can be slid upward until the mobile device clears the right side wall 110 and the left side wall 112.

With reference to FIG. 6B, the case 100 (e.g., the lower case portion 103 of a two-piece case, or a housing of a single-piece case) can have one or more vents 107, which can enable air exchange between the interior of the case 100 (e.g., the area containing the battery 140, circuitry 125, wireless receiver 124, and/or wireless transmitter 128) and the area outside the case 100. Warmer air from inside the case 100 can escape, and cooler are from outside the case 100 can enter the case interior. This can facilitate cooling components in the case 100. In some embodiments, the case 100 can include a fan (not shown), or other air circulator that can actively move air into or out of the case 100. The case 100 can include heat sink elements to draw heat out of interior components. The heat sink elements (not shown) can be disposed near the one or more vents 107 to facilitate cooling of the heat sink elements. In some configurations, the case 100 can have one or more vent openings 107 on a bottom side of the case 100, although other configurations are possible. A plurality of vent openings 107 can be positioned on a right side of the external interface 108, and a plurality of vent openings 107 can be positioned on a left side of the external interface, for example.

With reference to FIG. 6B, in some embodiments, the case can include a wireless charging indicator 109, which can be light or other user output element that outputs information to a user. The light of the wireless charging indicator 109 can illuminate when the case is wirelessly charging the mobile device and/or when the battery 140 of the case is being charged wirelessly.

Wireless Battery Attachment

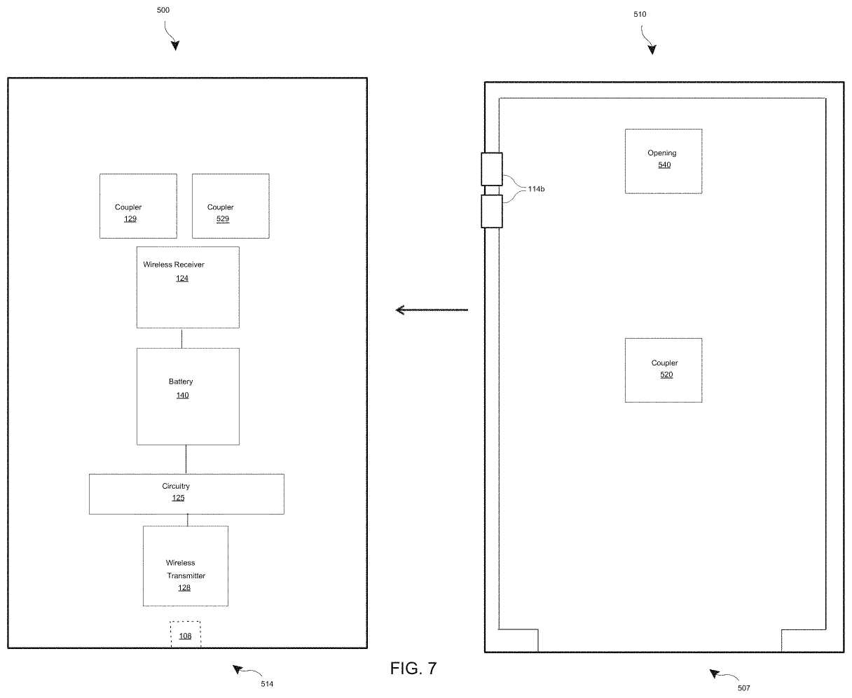

FIG. 7 is a schematic block diagram of a wireless battery attachment 500 and a protective case 510. The protective case 510 can be configured to house a mobile device 120. In some embodiments, the case 510 can be made of flexible or elastic material, such as thermoplastic polyurethane (TPU). The case 510 is shaped to closely wrap around the mobile device 120 and serves as a protective case for the mobile device 100. The case 510 can be formed with a recess 507 in a bottom wall of the case 510, such that at least a portion of a bottom of the mobile device 120 is not covered when housed within the case 510. The recess 514 can allow for access to the bottom of the mobile device 120, such as to provide access to a mobile device interface 121 and/or one or more speakers or microphones. The case 510 can have an external shape that generally corresponds to the external shape of the mobile device 120. Accordingly, a case 510 designed for use with a smartphone can have an external shape that generally corresponds to the external shape of the smartphone. Accordingly, the case 510 with the smartphone therein can be used in the same manner as the smartphone without the case 510. For example, the case 510 with the smartphone therein can be placed in a user's pocket, can be held in a single hand with the thumb operating the touchscreen, can comfortably be held to the user's face when talking on the phone, etc. The case 510 can have a front opening 540, which can provide access to a display (e.g., a touchscreen) of the mobile electronic device. The case 510 can have one or more flexible walls, which can flex to facilitate insertion of the mobile device into the case 510 and/or removal of the mobile device from the case 510. The case 510 can have a back wall and side walls, such as similar to the case 100 discussed herein. The case 510 can be a single-piece case or a two-piece case (e.g., similar to FIGS. 6A-6C). In some embodiments, the case 510 does not have a battery, circuitry, wireless charging features, etc. The case 510 can be a simple protective covering.

In some embodiments, the case 510 can be configured to couple with the wireless battery attachment 500. The case 510 can include a coupler 520, such as one or more magnets and/or magnetic materials (e.g., iron or other magnetic metal) to facilitate alignment with the wireless battery attachment 500. For example, the case 510 may also include one or more magnets, such that when the case 510 is placed within magnetic range of the wireless battery attachment 500, the one or more magnets in the case 510 are pulled towards and/or aligned with one or more magnets in the wireless battery attachment 500. The wireless battery attachment 500 may be configured to be attached to one or more external sides of the case 510, such as the back side thereof. The case 510 and/or the wireless battery attachment 500 can use a magnetic material (e.g., iron or another magnetic metal) instead of the magnets, for coupling.

The wireless battery attachment 500 and/or the case 510 can have features similar to the wireless battery case 100, and the features described in connection with the wireless battery case 100 can apply to the wireless battery attachment 500 and/or the case 510. For example, when the wireless battery attachment 500 and the case 510 are coupled, they can operate in the same manner and have the same features discussed in connection with the wireless battery case 100. However, in some embodiments the wireless battery case 100 can be a single piece unit, whereas the wireless battery attachment 500 can be removed from the case 510. For example, if a user wants the protection of the case but does not need additional battery capacity, the user can use the case 510 only, without the wireless battery attachment 500. This can result in a smaller (e.g., thinner) assembly, as compared to the case 100. If at a different time that user wants both the protection and added battery capacity, the user can couple the wireless battery attachment 500 to the case 510. Accordingly, the user can transition the system between a simple case that does not have the added bulk and weight of the supplemental battery 140, and a case that includes the supplemental battery 140 for additional battery capacity, without removing the electronic device from the case 510.

The wireless battery attachment 500 can include a battery 140, wireless receiver 124, and wireless transmitter 128, similar to the wireless battery case 100 discussed herein. These components can operate in a similar fashion as described above with reference to the wireless battery case 100. In some embodiments, the wireless battery attachment 500 may comprise a coupling element 529, such as one or more magnets, which can operate in connection with the coupler 520 of the case 510. The wireless battery attachment 500 can also include a coupler 129 (e.g., one or more magnets) for coupling with coupler 136 of the wireless charger 130 in substantially the same manner that the wireless battery case 100 is coupled to the wireless charger, as discussed herein. In some embodiments, the same coupler can operate as the coupler 129 and also the coupler 529 on the battery attachment 500, such as one or more magnets that produce a sufficient magnetic field on the front side and the back side of the battery attachment 500. In some embodiments, the magnets on the battery attachment 500 are configured to operate with corresponding magnets in the case 510 in order to facilitate proper positioning and/or alignment of the wireless transmitter 128 and the mobile receiver 131, such as to provide, improve, or optimize wireless charging capabilities. Such positioning and/or alignment may facilitate proper coupling of the wireless battery attachment 500 with the case 510 and thereby with the mobile device 120 (e.g., to enable, improve, or optimize communication between the wireless transmitter 128 and the mobile receiver 131). Respective wireless charging input and/or output interfaces in the mobile device 120 and the wireless battery attachment 500 (e.g., the wireless transmitter 128 and the wireless receiver 131) may be positioned such that when the one or more magnets of the case 510 align with the one or more magnets of the wireless battery attachment 500, the wireless input/output interfaces may also be aligned and/or otherwise in sufficiently close proximity to enable, improve, or optimize wireless transfer of electrical power (e.g., from the wireless battery attachment 100 to the mobile device 120).

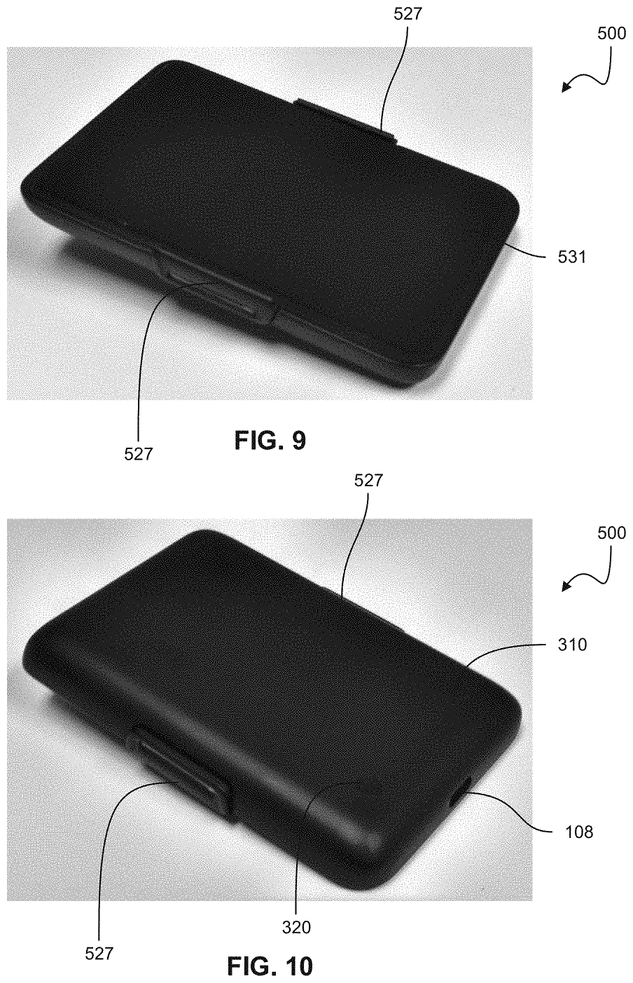

In some embodiments, the wireless battery attachment 500 can include a shape that generally corresponds to the shape of the mobile device 120 and/or the case 510. For instance, the wireless battery attachment 500 can include a camera opening 518 positioned (e.g., through a back wall 502) to align with a camera and/or camera flash on the mobile electronic device 120 so that the camera of the mobile electronic device 120 can operate while the wireless battery attachment 500 is attached to the case 510. The camera opening 518 can be configured to align with a camera opening on the case 510 when the battery attachment 500 is coupled to the case 510. The front of the battery attachment 500 can have a contour that matches the contour of the back side of the case 510. In some cases, the battery attachment 500 can have a footprint area (when viewed from the back) that is smaller than the footprint area of the case 510 (e.g., see FIGS. 9, 10, and 11).

In some cases, the battery attachment 500 can be configured to be used with the mobile device 120 without the case 510, as well as with the mobile device 120 when in the case 510. For example, the battery attachment 500 can be coupled directly to the mobile electronic device 120 (e.g., onto the back side thereof). The case 510 can be omitted, and the battery attachment 500 can be used directly with electronic devices for wireless charging. In some cases, the mobile device 120 can have a coupler (e.g., one or more magnet, pieces of magnetic material (e.g., containing iron)) which can couple to the coupler 529 on the battery attachment 500 to position and/or orient the wireless transmitter 128 of the battery attachment 500 relative to the wireless receiver 131 of the mobile device for transfer of wireless signals (e.g., for charging). In some embodiments, the coupler 520 on the case 510 can be omitted, and a coupler on the mobile device 120 (e.g., similar to the coupler 520) can operate to couple the battery attachment 500 to the mobile device 120 and case 510. The coupler on the mobile device 120 can be configured to function while the case 510 is on the mobile device 120. For example, the back wall of the case 510 can be sufficiently thin and of appropriate material to permit the magnetism of the couplers to operate through the back wall of the case 510. Also, the back wall of the case 510 can be configured (e.g., sufficiently thin and of an appropriate material) so that the wireless signals can be transmitted through the back wall of the case 510 (e.g., for charging or data transfer). The coupler 520 can be configured similarly to the coupler (not shown) on the mobile device 120, so that the battery attachment 500 can be selectively coupled to either the case 510 or the mobile device directly. In some embodiments, the back of the case 510 can have a contour similar to the back of the mobile device 120, such as so that the front contour of the battery attachment 500 can sit flush against either the case 510 or the mobile device 120 directly. In some embodiments, the wireless battery attachment 500 is configured to couple directly to the mobile device 120. For instance, the couplers 529 of the wireless battery attachment 500 can be configured to couple directly to the mobile device 120. In some cases, the case 510 can be omitted.

Many alternatives for coupling wireless battery attachment 500 to the case 510 and/or to the mobile device 120 are possible. In some embodiments, the couplers 529, 520 may be a latching or clipping mechanisms configured to secure the case 510 to the wireless battery attachment 500 in a proper orientation. In some embodiments, the shape or design of the wireless battery attachment 500 and/or the case 510 may encourage a user to join the case 510 and the wireless battery attachment 500 in a proper orientation for coupling and also for transfer of wireless signals.

With reference to FIGS. 9 to 11, the battery attachment 500 can have one or more clips 527, which can engage corresponding clip features (e.g., one or more protrusions or indentations configured to engage the one or more clips) to attach the battery attachment 500 to the case 510. The clips 527 can move (e.g., pivot) between an engagement position and a release position. For example, pressing on the rearward portion of the clip 527 can cause the clip 527 to pivot so that the front of the clip 527 moves outward, to the release position. The user can pinch the rearward portions of the two clips together to release or detach the battery attachment 500 from the case 510.

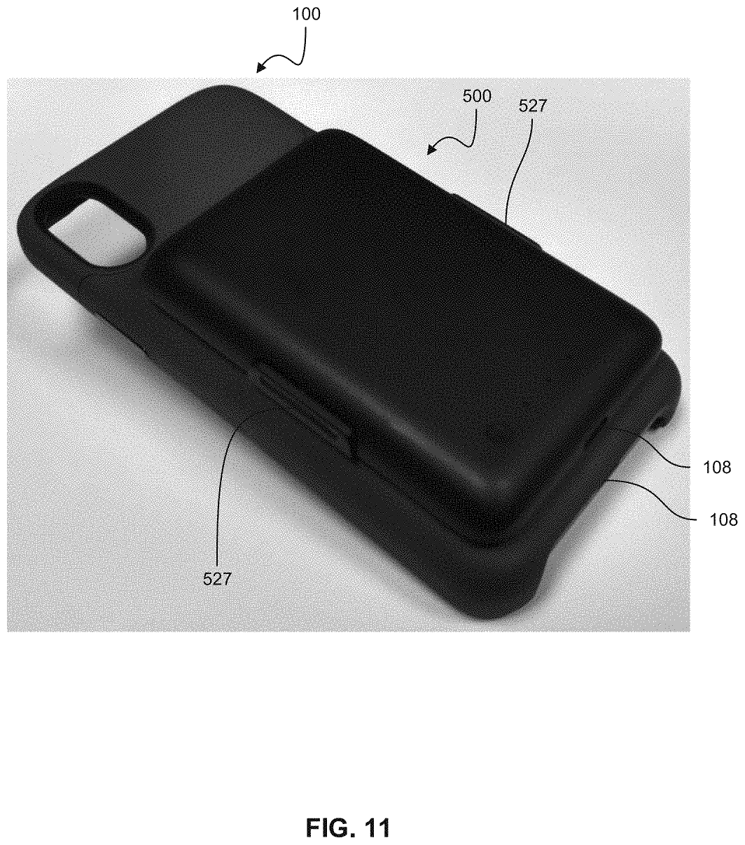

In some embodiments, the battery attachment 500 can have one or more suction elements for coupling the battery attachment 500 to the case 510 and/or directly to the mobile device 120. The battery attachment 500 can have one or more suction cups on the front surface thereof, which can suction against a back side of the case 510 or mobile device 120. The battery attachment 500 can have microsuction elements 531, such as microsuction tape, on a front surface thereof, which can suction against a back side of the case 510 or mobile device 120. The microsuction elements can have many craters (e.g., surface bubbles) formed in a deformable base material, so that pressing the material against a surface pushes air out of the craters. The craters can act as miniature suction cups. FIG. 11 shows the battery attachment 500 coupled to a back side of the wireless case 100. In this example, the battery attachment 500 is coupled to the case 100 using microsuction tape 531 (e.g., the clips 527 can be omitted). The battery attachment 500 can be used to charge the battery case 500, as discussed herein.

In some cases, the wireless battery attachment 500 can include a recess 514 in a bottom wall configured such that a bottom of the mobile device 120 is not covered when the wireless battery attachment is coupled to the case 510. The recess 514 can allow for access to the bottom of the mobile device 120. In some cases, the battery attachment 500 does not have a recess 514. For example, the battery attachment 500, in some cases, does not have a bottom wall that would impede access to the bottom of the mobile device 120.

In some embodiments, the battery 140 of the wireless battery attachment 500 can be charged by a wired connection (e.g., via an electrical port of interface 108) or wireless connection (e.g., using a wireless charger 130). The battery attachment 500 can have another coupler 129 on the back side, which can be used to couple the battery attachment 500 to the charger 130, similar to the discussion herein. The battery attachment 500 can be charged while separated from the mobile device 120 and/or the case 510. Accordingly, the user can decouple the battery attachment 500 from the mobile device 120 and/or the case 510 and can continue to use the mobile device 120 and/or the case 510 while the battery attachment 500 is charging. Multiple battery attachments 500 can be used to further extend the use of the mobile electronic device 120 without needing to immobilize the mobile electronic device 120. For example, a user can use a first battery attachment 500 coupled to the mobile electronic device 120 while a second battery attachment 500 is charging (e.g., plugged into a power outlet or sitting on a base charger). When the charge of the first battery attachment is low or depleted, the user can merely decouple the first battery attachment 500 replace it with the second battery attachment 500. Then the first battery attachment 500 can optionally be charged while the second battery attachment 500 is being used with the mobile electronic device 120.

Data communication can be relayed through the battery attachment 500 similar to the disclosure herein relating to data communication through the battery case 100. The wireless receiver 124 and the wireless transmitter 128 can both be wireless transmitters/receivers, which can both send and receive wireless signals (e.g., for transferring data or electrical power). In some cases, the battery attachment 500 can output charging signals to two devices (e.g., at the same time), such as by using both the wireless transmitter 124 and the wireless transmitter 128 to output charging signals.

Various embodiments disclosed herein can enable the mobile device 120 and the supplemental battery 140 to be charged at the same time (e.g., via different charging sources). For example, the phone can be charged via a wired connection to the mobile device interface 121 while the supplemental battery 140 is charged via a wired connection to the external interface 108 and/or via wireless charging signals, which can be received by the wireless receiver 124. The phone can be charged wirelessly using signals received by the wireless receiver 124, relayed to the wireless transmitter 128, and delivered to the mobile device 120 (e.g., bypassing the supplemental battery 140), and the supplemental battery 140 can be charged via a wired connection at the external interface 108. In some cases, charging signals can be received via a wired connection at the interface 108, then transmitted to the mobile device 120 using the wireless transmitter 128, for charging the mobile device 120 (e.g., bypassing the supplemental battery 140), and the supplemental battery 140 can be charged using wireless charging signals received via the wireless receiver 124. Charging the mobile device 120 and the supplemental battery 140 using different charging channels or different power sources can enable the mobile device 120 and/or the supplemental battery 140 to be charged more quickly than if a single power source or channel were split between charging both the mobile device 120 (e.g., battery 123) and the supplemental battery 140.

Various embodiments disclosed herein can enable data communication while charging. For example, data can be transferred to or from the mobile device via the mobile device interface 121, and the mobile device 120 can be charged or powered wirelessly via the wireless transmitter 128, and/or the supplemental battery 140 can be charged via the external interface 108. Accordingly, music videos or other media can be streamed from the mobile device 120 (e.g., via a wired connection), while it is being charged or powered wirelessly. Also, the mobile device interface 121 can be used for headphones, speakers, etc. while the mobile device 120 is being charged or powered wirelessly.

The wireless receiver/transmitter 124 and the wireless transmitter/receiver 128 can be positioned at various different suitable locations. For example, they can be offset as shown in FIGS. 4 and 5. In some embodiments, they can be aligned, at least partially overlapping, or substantially overlapping, in the direction extending between the front and back of the case 100 or battery attachment 500. Shielding material can be disposed between the wireless receiver/transmitter 124 and the wireless transmitter/receiver 128 to impeded crosstalk between the wireless receiver/transmitter 124 and the wireless transmitter/receiver 128. In some embodiments, an antenna (e.g., coil) of the wireless receiver/transmitter 124 can be positioned rearward of the supplemental battery 140 and the wireless transmitter/receiver 128 can be positioned forward of the supplemental battery 140.

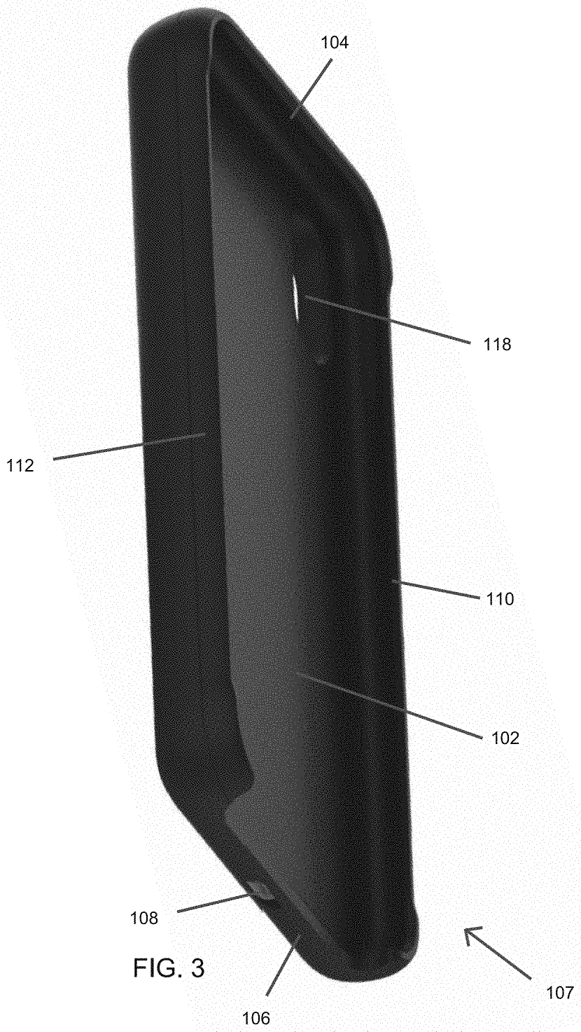

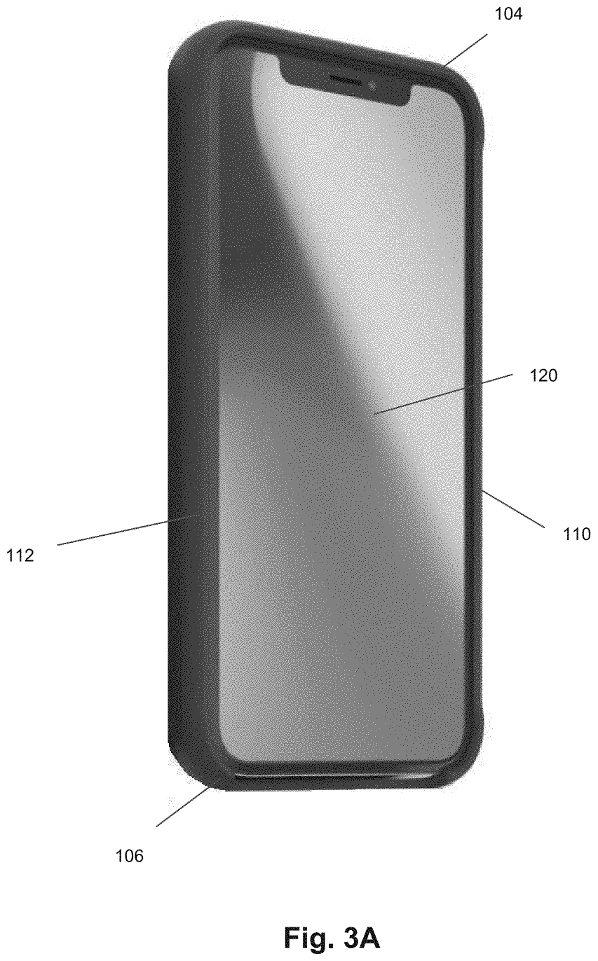

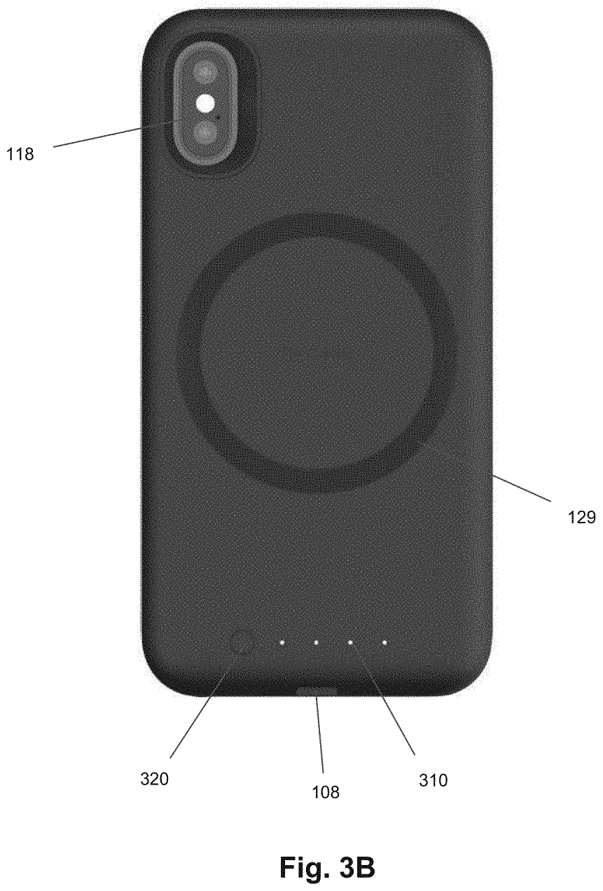

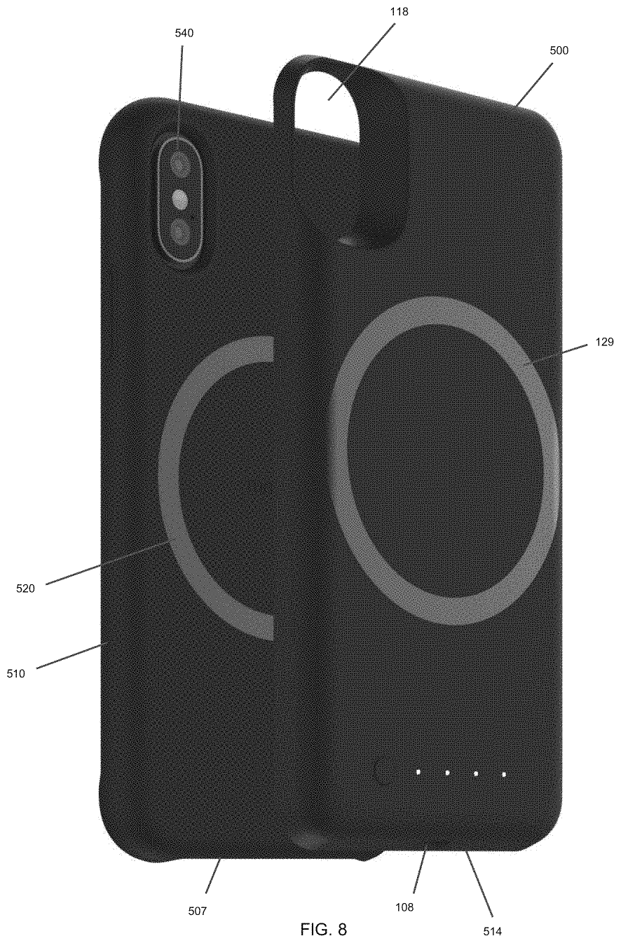

The couplers disclosed herein can include one or more magnets and/or one or more magnetic materials (e.g., a metal such as including iron). In some cases, the couplers can include magnets of alternating polarity, which can facilitate proper orientation of the antennas. In some cases, the coupler can include a charge-positioning ring, as can be seen in certain figures disclosed herein. In some embodiments, a visible ring or other shape can be seen on the outside of the case or charger (e.g., as can be seen in FIGS. 3B and 8), which can indicate the presence or location of the coupler. In some embodiments, the coupler can be inside the device and hidden from view, such as with no ring or visible external component. The rings shown herein (e.g., in FIGS. 3B and 8) can indicate a visible external component, or can schematically illustrate the location of a coupler that is not visible from outside the device. In some embodiments, the couplers can be omitted entirely.

In some embodiments, the supplemental battery 140, circuitry 125, wireless transmitter 128, and wireless receiver 124 can be positioned behind the mobile device 120, such as contained within the footprint area of the mobile electronic device 120. The mobile electronic device 120 (or the opening 118 or 540) can fill about 75%, about 80%, about 85%, about 90%, about 92%, about 94%, about 95%, about 96%, about 97%, about 98%, or about 99% of the footprint of the case 100 or 510. Some battery cases have an internal interface that engages the mobile device interface 121, so that at least some circuitry is disposed under the bottom side of the mobile electronic device. The battery cases can include a “chin” area at the bottom. That area can also include channels for delivering sound to or from the one or more speakers or microphones. The embodiments that omit the “chin” area can enable the cases to be smaller with a larger percentage of the front area occupied by the mobile device 120 (e.g., by the display).

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

What is claimed is:

1. A wireless battery case for use with a mobile electronic device, the wireless battery case comprising:
a back wall configured to extend across at least a portion of a back of a mobile electronic device;
a top wall configured to extend along at least a portion of a top of the mobile electronic device;
a right side wall configured to extend along at least a portion of a right side of the mobile electronic device;
a left side wall configured to extend along at least a portion of a left side of the mobile electronic device;
a front opening configured such that a display of the mobile electronic device is visible through the front opening;
a battery housed within the back wall of the wireless battery case;
a wireless receiver coupled to the battery, the wireless receiver configured to receive wireless signals, wherein the battery is charged in response to the wireless signals;
a wireless transmitter coupled to the battery, the wireless transmitter configured to receive charging signals from the battery and to wirelessly provide wireless signals to the mobile electronic device in response to the charging signals from the battery; and
an external interface configured to receive a wired connection for charging the battery;
wherein the case is configured to receive the mobile electronic device so that a mobile device interface of the mobile electronic device is exposed, wherein the mobile device interface is configured to receive a wired connection.

2. The wireless battery case of claim 1, comprising a bottom wall configured to extend along at least a portion of a bottom end of the mobile electronic device, the bottom wall configured such that at least a portion of a bottom of the mobile electronic device is uncovered by the bottom wall so that the mobile device interface is exposed.

3. The wireless battery case of claim 1, wherein the wireless receiver is coupled to the wireless transmitter, and wherein the wireless receiver provides charging signals directly to the wireless transmitter without first storing the charging signals in the battery when operating in a bypass mode.

4. The wireless battery case of claim 1, wherein one or more of the back wall, the top wall, the right side wall, and the left side wall is flexible such that the mobile electronic device can pass through the front opening and be securely disposed within the wireless case.

5. The wireless battery case of claim 1, wherein the wireless case is configured to house a smartphone, and wherein the wireless case has an external shape that generally corresponds to an external shape of the smartphone.

6. The wireless battery case of claim 1, comprising an upper case portion and a lower case portion, wherein the upper case portion is removable from the lower case portion to facilitate insertion of the mobile electronic device into the case and/or to facilitate removal of the mobile electronic device from the case.

7. A wireless battery case for use with a mobile electronic device, the wireless battery case comprising:
a back wall configured to extend across at least a portion of a back of a mobile electronic device;
a top wall configured to extend along at least a portion of a top of the mobile electronic device;
a bottom wall configured to extend along at least a portion of a bottom end of the mobile electronic device, the bottom wall comprising a recess configured to expose a mobile device interface of the mobile electronic device so that the mobile device interface is able to receive a wired connection while the mobile electronic device is in the case;
a right side wall configured to extend along at least a portion of a right side of the mobile electronic device;
a left side wall configured to extend along at least a portion of a left side of the mobile electronic device;
a front opening configured such that a display of the mobile electronic device is visible through the front opening;
a battery housed within the back wall of the wireless battery case;
a wireless receiver coupled to receive wireless charging signals;
a wireless transmitter configured to transmit wireless charging signals;
an external interface configured to receive a wired connection;
wherein a first charging mode receives wireless charging signals through the wireless receiver and sends corresponding wireless charging signals through the wireless transmitter to the mobile electronic device;
wherein a second charging mode receives wireless charging signals through the wireless receiver for charging the battery of the case;
wherein a third charging mode receives electrical power via a wired connection to the external interface, and wherein the electrical power is used to transmit wireless charging signals through the wireless transmitter to the mobile electronic device; and
wherein a fourth charging mode receives electrical power via a wired connection to the external interface, and wherein the electrical power is used to charge the battery of the case.

8. The wireless battery case of claim 8, wherein one or more of the back wall, the top wall, the bottom wall, the right side wall, and the left side wall is flexible such that the mobile electronic device can pass through the front opening and be securely disposed within the wireless case.

9. The wireless battery case of claim 8, wherein the wireless case is configured to house a smartphone, and wherein the wireless case has an external shape that generally corresponds to an external shape of the smartphone.

10. The wireless battery case of claim 8, comprising an upper case portion and a lower case portion, wherein the upper case portion is removable from the lower case portion to facilitate insertion of the mobile electronic device into the case and/or to facilitate removal of the mobile electronic device from the case.

11. A wireless battery case for use with a mobile electronic device, the wireless battery case comprising:
a back wall configured to extend across at least a portion of a back of a mobile electronic device;
a top wall configured to extend along at least a portion of a top of the mobile electronic device;
a bottom wall configured to extend along at least a portion of a bottom end of the mobile electronic device, the bottom wall configured such that at least a portion of a bottom of the mobile electronic device is uncovered by the bottom wall;
a right side wall configured to extend along at least a portion of a right side of the mobile electronic device;
a left side wall configured to extend along at least a portion of a left side of the mobile electronic device;
a front opening configured such that a display of the mobile electronic device is visible through the front opening;
a battery housed within the back wall of the wireless battery case;
a wireless receiver coupled to the battery, the wireless receiver configured to receive wireless signals, wherein the battery is charged in response to the wireless signals; and
a wireless transmitter coupled to the battery, the wireless transmitter configured to receive charging signals from the battery and to wirelessly provide wireless signals to the mobile electronic device in response to the charging signals from the battery.

12. The wireless battery case of claim 12, further comprising an external interface configured to receive a wired connection for charging the battery.

13. The wireless battery case of claim 12, wherein the external interface is further configured to provide electrical power to the wireless transmitter.

14. The wireless battery case of claim 12, wherein the external interface comprises a USB port.

15. The wireless battery case of claim 12, wherein the wireless receiver is configured to provide electrical power to another mobile electronic device.

16. The wireless battery case of claim 12, wherein the wireless receiver is configured to switch between a receiving mode and a transmitting mode.

17. The wireless battery case of claim 12, wherein the wireless receiver is coupled to the wireless transmitter, and wherein the wireless receiver provides charging signals directly to the wireless transmitter without first storing the charging signals in the battery when operating in a bypass mode.

18. The wireless battery case of claim 12, wherein the charging signals comprise electrical power.

19. The wireless battery case of claim 12, wherein the wireless receiver comprises a wireless charging receiver coil.

20. The wireless battery case of claim 12, wherein the bottom wall provides access for a wired connector to engage a corresponding interface of the mobile electronic device.

21. The wireless battery case of claim 12, wherein one or more of the back wall, the top wall, the bottom wall, the right side wall, and the left side wall is flexible such that the mobile electronic device can pass through the front opening and be securely disposed within the wireless case.

22. The wireless battery case of claim 12, wherein the wireless case is configured to house a smartphone, and wherein the wireless case has an external shape that generally corresponds to an external shape of the smartphone.

23. The wireless battery case of claim 12, further comprising a charge indicator configured to indicate the charge status of the battery, wherein the charge indicator comprises a plurality of light emitting diodes (LEDs).

24. The wireless battery case of claim 12, comprising an upper case portion and a lower case portion, wherein the upper case portion is removable from the lower case portion to facilitate insertion of the mobile electronic device into the case and/or to facilitate removal of the mobile electronic device from the case.

25. The wireless battery case of claim 12, comprising vents for cooling an interior of the case.
